(19) United States
(12) Patent Application Publication
(10) Pub. No.: US 2002/0049897 A1
(43) Pub. Date: Apr. 25, 2002

(54) Method for adding processor

(76) Inventors: Tomoki Sekiguchi, Sagamihara (JP); Toshiaki Arai, Machida (JP); Hirofumi Yamashita, Yokohama (JP)

Correspondence Address: MATTINGLY, STANGER & MALUR, P.C., 104 EAST HUME AVENUE, ALEXANDRIA, VA, 22301, US

(21) Appl. No.: 09/795,109

(22) Filed: Mar. 1, 2001

(30) Foreign Application Priority Data
Oct. 20, 2000 (JP) 2000-321327

(51) Int. Cl. G06F 9/00; G06F 9/24; G06F 15/177

(52) U.S. Cl. 713/1

(57) ABSTRACT

For dynamically adding a processor during execution of an operating system, a processor which is not installed in a computer is virtually formed during starting of the OS. A processor installed in the computer is forced to execute OS initialization inherent to the virtually formed processor. After the initialization, from among installed processors, a processor is specified for executing the OS. When the virtually formed processor, not installed in the computer, is actually added, the added processor is joined in the execution of the OS.

### BACKGROUND OF THE INVENTION

The present invention relates to a computer processing technique, and more particularly, to a technique for adding a processor during execution of OS (Operating System).

A demand for higher processing performance of a server computer is rapidly on the rise, so that it becomes difficult to predict how high performance the computer will be required to provide in the future. Also, the widespread Internet forces the server computer to reduce a time for which it can stop the service. The computer must be shut down for installation of additional resources, particularly, for installation of additional CPU in order to improve the performance of the computer. However, the shut-down of the computer results in a blank of service and a degraded quality. For this reason, there is an increasing need for strategies of increasing the processing performance without shutting down the computer.

The following two prior art techniques are presented as related to the present invention.

(a) An example of prior art technique for adding a CPU during execution of a computer (a system for dynamically adding a CPU) is described in Dec. 20, 1999 issue of Nikkei Computer, p. 16 (published by Nikkei BP Inc.). In this system, a plurality of CPUs have been installed beforehand in a computer, so that a user of the computer purchases a license for a number of CPUs to be utilized from among the installed CPUs. The OS boots all the installed CPUs such that they are all available, but after the CPUs have been booted, controls the CPUs in accordance with the CPU license previously granted to the user, so that unlicensed CPUs are brought into an idle state. When the user of the computer requires more than the previously licensed CPUs, the user may purchase an additional license. As an associated parameter is set in the OS in accordance with the additional license, the OS performs scheduling to allow the CPUs, which have been idling, to execute processes, thereby apparently adding CPUs without shutting down the computer.

(b) JP-A-11-53333 describes a configuration in which the OS initially recognizes a maximum number of installable CPUs and the number of actually installed CPUs, and initializes the data structure within the OS. In this system, CPU that would be added later need not to be installed beforehand, and CPUs may be added at a later time and joined in the execution of the OS. Stated another way, this system is designed on the assumption that CPUs are additionally installed, so that the OS is configured to support the additional installation of CPUs.

When the OS does not support the addition of CPUs, this means that the internal data structure thereof depends on the number of CPUs at the time a computer is started. The OS examines the number of CPUs which are installed upon starting the computer, and initializes the data structure internal to the OS in accordance with the number of CPUs. For example, in accordance with the number of installed CPUs, the OS executes initialization such as assignment of a buffer for preserving management data for each of the CPUs and a buffer for memory allocation for each of the CPUs (Inside Win2K Salability Enhancements, Part 1: Windows 2000 Magazine, Oct. 4, 1999, pp. 1-8). Such assignment of data structure is an approach commonly used in the OS for multiprocessor computers. In this way, the OS initializes the internal data structure in accordance with the number of installed CPUs.

The aforementioned system (a) has a problem of an increased manufacturing cost because CPUs must be actually installed in the computer. Also, such a system is employed because the OS does not support dynamic CPU addition. In addition, it is difficult to modify an existing OS so as to support the dynamic CPU addition.

With the OS as described above, which initializes the internal data structure in accordance with the number of installed CPUs at the time the computer is started, even if a CPU is added afterwards, the internal data structure does not support the added CPU, so that the added CPU cannot be joined in the execution of the OS. Further, in the OS which has a device driver separate from an OS kernel, initialization depending on the number of CPUs disperses within the OS, thus making it difficult to fully modify those proceedings so as to support the CPU addition. In other words, in the prior art dynamic CPU addition as described above, the OS must have functions to support the dynamic CPU addition.

If the OS does not support the dynamic CPU addition, the processes depending on the number of CPUs disperses in the OS, thus making it difficult to modify the OS to support the dynamic CPU addition. For this reason, when such OS is used, a number of installable CPUs have been previously installed in a computer for accommodating an increased load on the computer, and the OS controls the number of CPUs that execute the OS, based on license information to realize apparent dynamic CPU addition. Since this system must have CPUs previously installed in the computer, a problem arises in that the manufacturing cost of the computer is increased, as described above.

Also, some OS can support a faulty CPU, which may be found upon starting the OS, in such a manner that the OS boots CPUs except for the faulty CPU. However, with the OS which structurally depends on the number of CPUs as described above, even if the faulty CPU is removed and a normal CPU is added instead, the added CPU cannot be joined in the execution of the OS. In such a case, therefore, the computer must be once shut down and restarted.

### SUMMARY OF THE INVENTION

It is an object of the present invention (1) to enable dynamic processor addition during execution of the OS even if a processor, which would have to be added later, is not previously installed, and (2) to enable a faulty processor, if any, upon starting the OS, to be replaced with a normal processor without restarting the computer.

To achieve the above object, a method of adding a processor according to one aspect of the present invention comprises a first step of virtually forming a processor not installed in a computer when the computer boots during execution of an operating system (OS), a second step of forcing an installed processor to execute OS initialization inherent to each virtually formed processor in non-installed processor's behalf, a third step of specifying a processor from among installed processors for executing the OS after the initialization, and a fourth step, executed when a processor is added, of loading the result of the initialization to the added processor and joining the added processor in the execution of the OS.

A method of adding a processor according to another aspect of the present invention comprises a first step of virtually forming a processor N not installed in a computer when the processor boots the computer during execution of an operating system (OS), a second step of selecting an arbitrary installed processor A before the OS boots the non-installed processor N, preserving status of the installed processor A, and executing OS initialization inherent to the non-installed processor N on the installed processor A instead of the non-installed processor N, a third step of preserving the status of the installed processor A as status of the non-installed processor N after the initialization, a fourth step of restoring the status of the preserved installed processor A to resume the execution of the OS, and a fifth step, executed when an N-th processor is added, of restoring the status of the non-installed processor N, which is preserved upon completion of the initialization, in the added processor, and joining the added processor in the execution of the OS.

### BRIEF DESCRIPTION OF THE DRAWINGS

FIG. 1 is a block diagram illustrating an exemplary configuration of a computer system according to an embodiment;

FIG. 2 is a block diagram illustrating the configuration of software in the embodiment of FIG. 1;

FIG. 3 is a flow chart illustrating a procedure of starting the OS in the embodiment of FIG. 1;

FIG. 4 is a flow chart illustrating a procedure of initialization inherent to each CPU;

FIG. 5 is a flow chart illustrating a trapping process in a CPU virtualization program;

FIG. 6 is a diagram showing the structure of a CPU management table;

FIG. 7 is a flow chart illustrating a process to restrict CPUs that execute the OS;

FIG. 8 is a flow chart illustrating a procedure of adding a CPU;

FIG. 9 is a flow chart illustrating a process procedure of a scheduler;

FIG. 10 is a diagram showing the structure of a CPU configuration table;

FIG. 11 is a block diagram illustrating an exemplary configuration of a computer according to another embodiment; and

FIG. 12 is a flow chart illustrating a procedure of booting CPUs according to a further embodiment.

### DESCRIPTION OF THE EMBODIMENTS

In the following, embodiments of the present invention will be described with reference to the accompanying drawings.

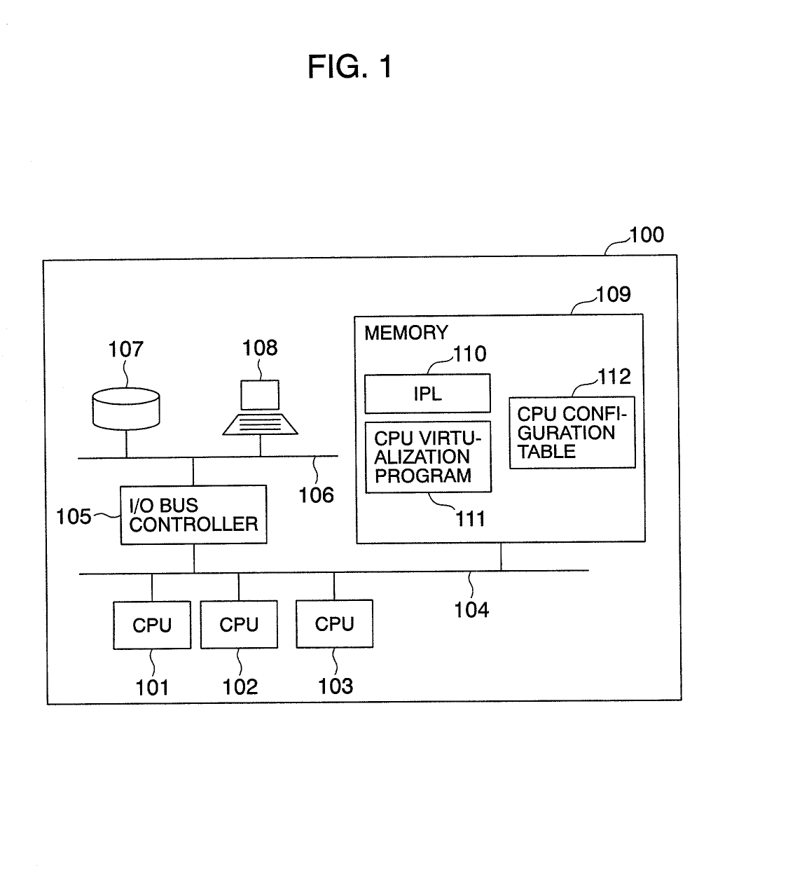

FIG. 1 is a block diagram illustrating an exemplary configuration of a computer system according to an embodiment of the present invention.

In FIG. 1, a computer, generally designated by reference numeral 100, comprises CPUs 101-103; an I/O bus controller 105; a memory 109; a bus 104; an I/O bus 106; a magnetic disk device 107; an input/output console 108; an initial program loader (IPL) 110; a CPU virtualization program 111; and a CPU configuration table 112. The CPU 101-103, I/O bus controller 105 and memory 109, which form part of the computer 100, are interconnected by the bus 104.

The I/O bus 106 is connected to the I/O bus controller 105. Input/output devices such as the magnetic disk device 107, input/output console 108 and so on are connected to the I/O bus 106. The I/O bus controller 105 controls communications of data with devices such as the magnetic disk device 107 and the input/output console 108, and routing of an external interrupt from a device to a CPU. The I/O bus controller 105 holds a table indicating which device can send an interrupt to which CPU. The contents of the table are set by the OS.

FIG. 1 shows that the memory 109 is loaded with the initial program loader (hereinafter called the “IPL”) 110 and the CPU virtualization program 111. The IPL 110 is a program which is initially executed upon starting the computer, and generally loads the OS executed by the computer 100 into the memory 109. In this embodiment, the IPL 110 loads the CPU virtualization program 111 instead of the OS. The CPU configuration table 112 in the memory 109 is a table which stores information on the configuration of the CPUs installed in the computer 100, and is built by the IPL 110. The structure of the table 112 will be described later.

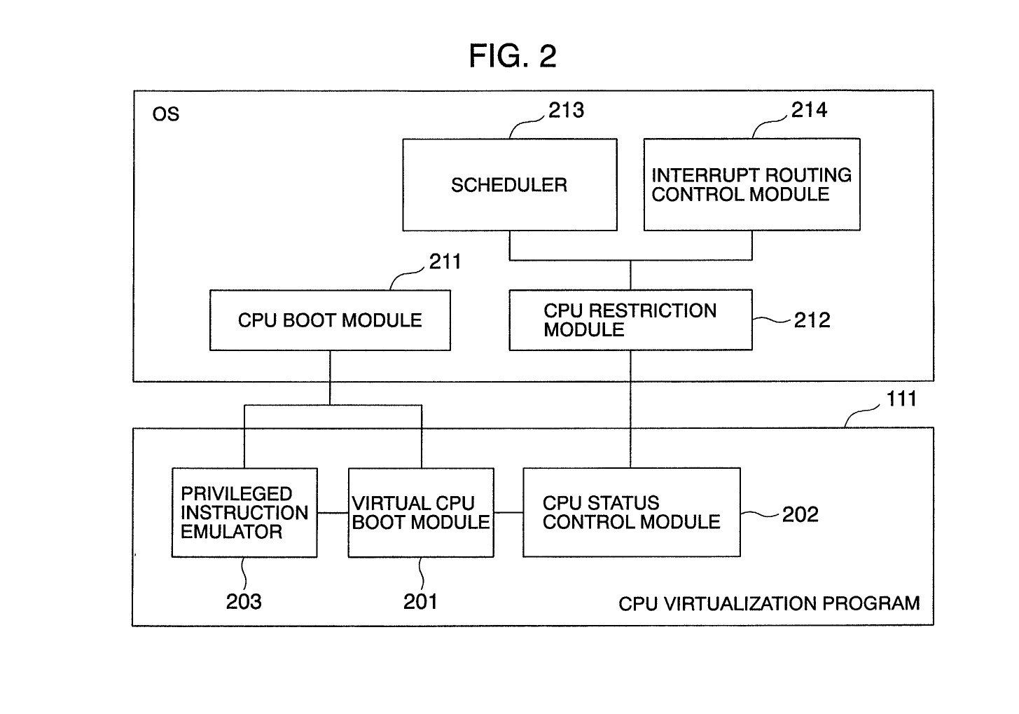

FIG. 2 illustrates the configuration of software in the embodiment illustrated in FIG. 1.

In FIG. 2, the CPU virtualization program 111 comprises a virtual CPU boot module 201; a CPU status control module 202, and a privileged instruction emulator 203. The virtual CPU boot module 201 is executed when a CPU boot instruction executed by a CPU boot module 211 of the OS is trapped. The virtual CPU boot module 201, associated with the CPU status control module CPU 202, creates the status of a CPU, which is not actually installed in the computer 100 (hereinafter called the “logical CPU”), on a CPU which is actually installed on the computer 100, to enable the OS to execute the CPU boot module 211, and subsequent OS initialization inherent to each CPU (OS initialization essentially executed by each CPU).

The CPU status control module 202 controls a correspondence relationship between physical CPUs and logical CPUs, the latter are conceived by the OS. The CPU status control module 202 manages execution status of logical CPUs, restores and preserves the status of logical CPUs, and allocates a physical CPU to a logical CPU. A logical CPU becomes executable after a physical CPU is allocated thereto.

The privileged instruction emulator 203 traps an I/O instruction, a privileged instruction, a virtual memory setting process and so on, executed by the OS, and emulates the process associated therewith. The privileged instruction emulator 203 also creates an OS execution environment such that a trap is generated when the OS executes a CPU boot instruction. The privileged instruction emulator 203 executes the virtual CPU boot module 201 when it traps the CPU boot instruction executed by the OS.

The OS running on the computer 100 executes the initialization of the OS, in association with the CPU virtualization program 111. For supporting the dynamic CPU addition, the OS is provided therein with the CPU boot module 211, a CPU restriction module 212, a scheduler 213, and an interrupt routing control module 214.

The CPU boot module 211 executes a process for booting CPUs installed in the computer 100. As the computer 100 is started, a bootstrap CPU (the CPU which first starts operating upon power-on) starts executing, and the OS starts running on the bootstrap CPU. The OS boots the remaining CPUs other than the bootstrap CPU during the initialization. The CPU restriction module 212 specifies CPUs on which the OS actually runs. The OS is started on the assumption that there are more CPUs, provided by the CPU virtualization program 111, than those actually installed in the computer 100. After completion of the initialization, the CPU restriction module 212 changes a schedule parameter of the OS and an interrupt routing path such that only physical CPUs actually execute the OS.

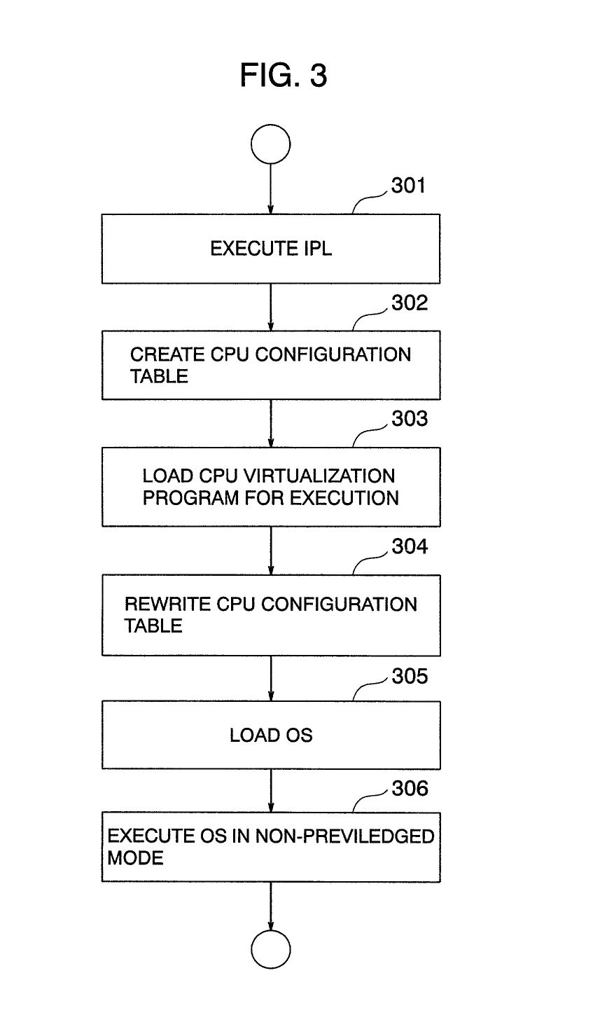

FIG. 3 is a flow chart illustrating a procedure of starting the OS in the embodiment of FIG. 1.

As the computer is started, the bootstrap CPU executes the IPL 110 (step 301). Assume herein that the bootstrap CPU is the CPU 101. The IPL 110 resides at a definite location in the memory 109, i.e., at an address at which the CPU 101 starts the execution after it is booted, so that the CPU 101 can execute the IPL 110. The IPL 110 scans the hardware to count CPUs actually installed in the computer 100, i.e., the physical CPUs, and creates the CPU configuration table 112 on the memory 109 (step 302).

Next, the CPU virtualization program 111 is loaded into the memory 109 for execution (step 303). Generally, the IPL 110 loads the OS, whereas in this embodiment, the IPL 110 is configured to load the CPU virtualization program 111. Steps 304 onward are executed by the CPU virtualization program 111. The CPU virtualization program 111 rewrites the CPU configuration table 112 for virtually changing the number of installed CPUs for the OS (step 304). Specifically, the CPU virtualization program 111 rewrites the CPU configuration table 112 such that it appears that a larger number of CPUs are installed in the computer 100 than the actually installed CPUs. Subsequently, the CPU virtualization program 111 loads the OS into the memory 109 (step 305).

The CPU virtualization program 111 sets an execution environment to execute the OS in a non-privileged mode of the CPU 101, and passes the control to the OS such that when the OS executes a privileged instruction, the privileged instruction emulator 203 of the CPU virtualization program 111 can take the control (step 306). In this way, the CPU boot process of the OS can be trapped.

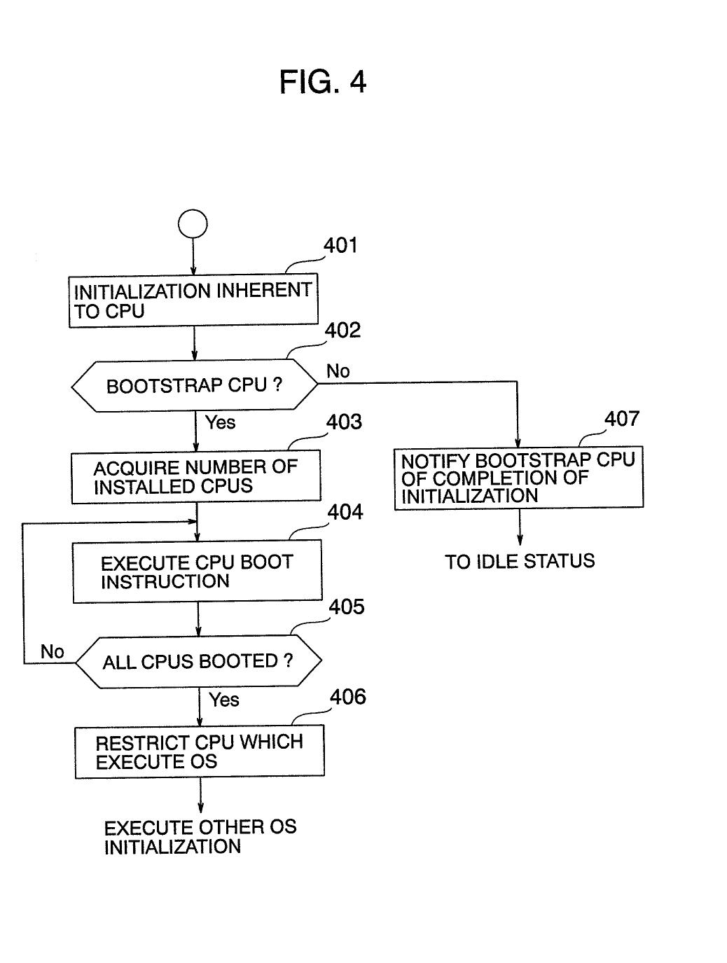

FIG. 4 is a flow chart illustrating a procedure of booting CPUs in the initialization of the OS, and a procedure of the initialization inherent to each CPU.

The process illustrated in FIG. 4 is executed by all CPUs as the initialization. As the computer 100 is started, the bootstrap CPU executes this process. First, the bootstrap CPU executes the initialization inherent to each CPU (step 401). Executed herein are setting of internal registers in the respective CPUs, allocation of a memory buffer for each of the CPUs, and so on. If it is the bootstrap CPU that executes this process (determined at step 402), the bootstrap CPU references the CPU configuration table 112 to acquire the number of CPUs installed in the computer 100 (step 403). The acquired number of CPUs is the number of CPUs which has been rewritten at step 304 of the CPU virtualization program 111, and therefore is larger than the number of actually installed CPUs.

Subsequently, the bootstrap CPU executes steps 404 and 405 for all the CPUs which are determined as installed. At step 404, the bootstrap CPU executes an instruction that boot a CPU. A method of booting a CPU, though different from one computer to another, is implemented by writing into a specific memory address, or an I/O instruction. Assume in this embodiment that a CPU is booted by writing into a boot address 1002, associated with the CPU to be booted, stored in the CPU configuration table 112.

The CPU virtualization program 111 controls the execution of the OS such that the execution of these instructions results in the generation of a trap. The trap generated in this event is captured and processed by the privileged instruction emulator 203 in the CPU virtualization program 111. For an instruction that boots an actually installed CPU, the instruction is executed as it is. Otherwise, a process for booting a virtually created CPU is executed. This trap process will be described later.

A CPU instructed to be booted, or a CPU which starts executing after a virtually booted CPU has started executing, again executes the process from step 401 for executing the initialization inherent to the CPU. After termination of step 401, the CPU notifies the bootstrap CPU of the termination (step 407), and transitions to an idle state.

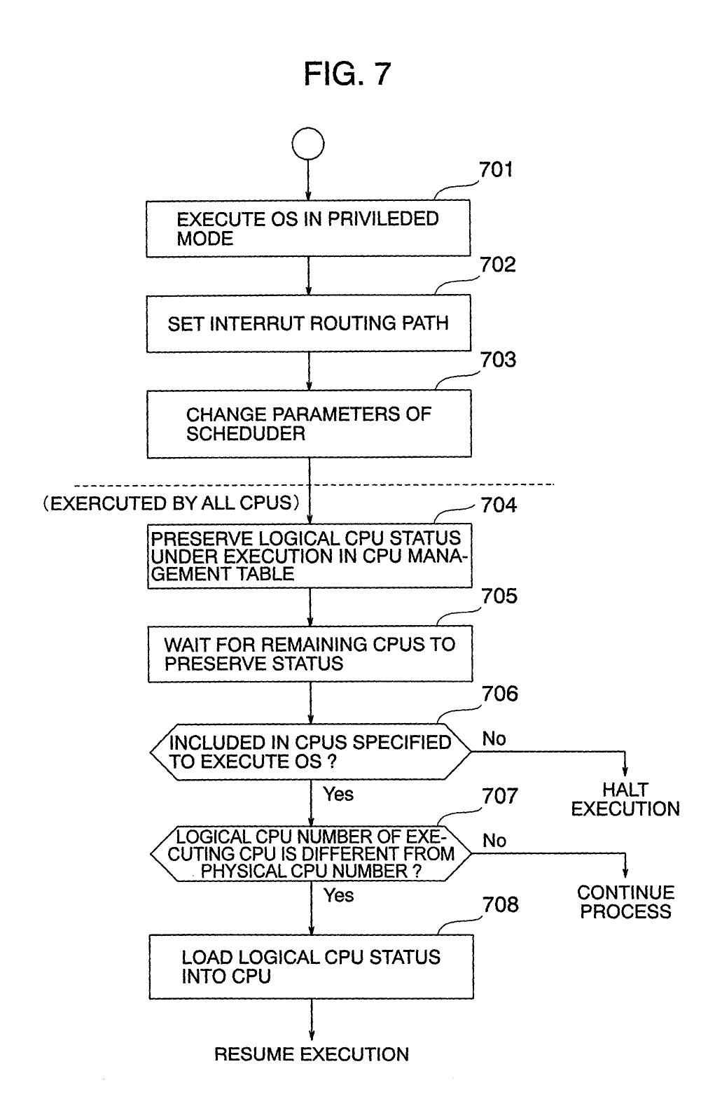

In this embodiment, when a virtual CPU is virtually booted by the CPU virtualization program 111, the foregoing process may be executed on the virtual CPU. During the execution, the bootstrap CPU waits for a notification from the CPU that the CPU has been booted (step 405). At the time the booting completion notices have been received from all CPUs, the OS detects that the initialization of the CPUs indicated in the CPU configuration table 112 has been completed. Consequently, the data structure is defined to enable these CPUs to execute the OS. Here, CPUs that execute the OS are restricted such that only those CPUs that are actually installed in the computer 100 are allowed to execute the OS (step 406). Subsequently, the procedure continues to execution of other initialization. The process at step 406 will be described later in connection with FIG. 7.

While the restriction of CPUs that execute the OS at step 406 is performed immediately after the CPUs have been booted in this embodiment, the completion of other initialization depending on the number of CPUs may be awaited before performing the restriction of CPUs that execute the OS.

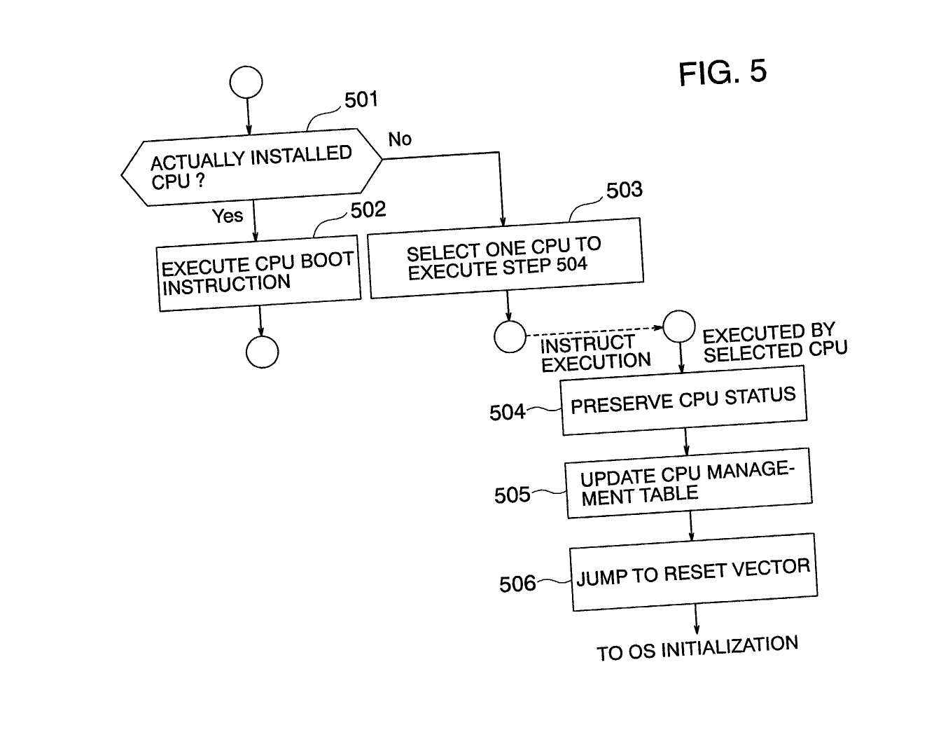

FIG. 5 is a flow chart illustrating the trapping process of the CPU virtualization program 111 when CPUs are booted.

As described above, when the OS executes the CPU boot instruction at step 404, a trap is generated, causing a transition of the control to the privileged instruction emulator 203 of the CPU virtualization program 111. Upon determining that the executed instruction is a CPU boot instruction, the privileged instruction emulator 203 activates the virtual CPU boot module 201. The virtual CPU boot module 201 determines whether or not a CPU to be booted is a CPU which is actually installed in the computer 100 (step 501). The virtual CPU boot module 201 references the contents of the CPU configuration table 112 before it is rewritten by the IPL 110 to determine whether or not the CPU to be booted is actually installed.

If the CPU is actually installed, the CPU boot instruction is executed as it is to boot the CPU (step 502). If the CPU is not installed, one of installed CPUs (physical CPUs) is selected, and the selected CPU is instructed to execute the CPU initialization at step 504 onward (step 503). Assume herein that an M-th logical CPU is to be booted, and a selected CPU is the CPU 103. The following description is made on the assumption that the CPU 103 is the third physical CPU and has been so far a third logical CPU. At step 503, an interrupt is transmitted to the CPU 103 to force the CPU 103 to start the process at step 504 onward.

The CPU 103 preserves the execution status of the CPU at that time in the CPU management table 600 (step 504). Then, the correspondence relationship between the logical CPUs and the physical CPUs in the CPU management table 600 is updated such that it indicates that no physical CPU is allocated to the third logical CPU, and the M-th logical CPU is being executed by the CPU 103 (step 505). Then, for emulating the CPU booting, the process jumps to an address (reset vector) at which the CPU starts executing when a reset is inputted (step 506).

In this way, the CPU 103 is booted as the M-th CPU to executes the OS initialization, and executes the process from step 401 in FIG. 4, which is the OS initialization inherent to the CPU. In this event, the OS executes the initialization inherent to the CPU on the assumption that the M-th CPU has been booted. Specifically, the OS initializes the internal data structure thereof on the assumption that the M-th CPU, which is not actually installed, exists, and sets registers and so on for this CPU. This process is executed instead by the CPU 103 which is the selected CPU.

In the subsequent OS initialization, when a communication is made between CPUs using an interrupt, particularly when a destined logical CPU has not been allocated a physical CPU, a special process is required. In this event, similarly to the CPU boot process as described above, one physical CPU is selected, its status is preserved, and the status of the destined logical CPU is set on the selected CPU to resume the execution. Also, since an interrupt between CPUs is implemented by a privileged instruction or an I/O instruction, the privileged instruction emulator 203 can trap and simulate the interrupt. An external interrupt may also be processed in a similar manner.

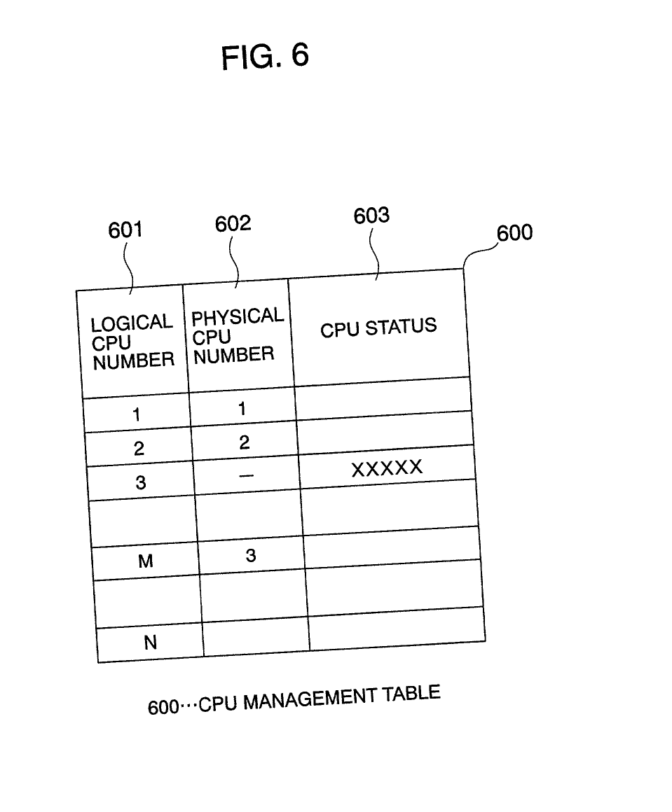

FIG. 6 shows the structure of the CPU management table 600.

The CPU management table 600, which is managed by the CPU status control module 202, holds, for each of logical CPUs, a logical CPU number 601; a number 602 of a physical CPU allocated to the logical CPU; and CPU status 603 which preserves the previous execution status of the logical CPU, if the logical CPU has not been allocated a physical CPU at a certain time. FIG. 6 shows the CPU management table 600 when the process of FIG. 5 has been executed up to step 505. Specifically, the third logical CPU has not been allocated a physical CPU so that its previous execution status is preserved, and an M-th logical CPU is executed by the CPU 103.

FIG. 7 is a flow chart illustrating a procedure of specifying a CPU which executes the OS (step 406 in FIG. 4).

Upon completion of the CPU-inherent initialization for all the CPUs, the OS executes the process to restrict CPUs that execute the OS, previously shown in FIG. 4 (step 406), to restrict the execution of the OS to physical CPUs (CPUs which are actually installed in the computer 100). First, at step 701, the execution of the OS is transitioned to a privileged mode. Next, at step 702, the I/O bus controller 105 is set such that external interrupts from devices are routed only to the physical CPUs. Subsequently, associated parameters of the scheduler are changed such that the OS is executed only on the physical CPUs (CPUs actually installed in the computer 100) (step 703).

The subsequent process from step 704 to step 708 is executed on all the CPUs installed in the computer 100. First, each of the CPUs preserves the current status thereof in the CPU status 603 of the CPU management table 600 (step 704), and waits for the remaining CPUs to preserve their status, respectively (step 705). Then, it is examined whether or not each physical CPU under execution is included in specified CPUs as utilized (CPUs which execute the OS) (step 706). The execution of a physical CPU is halted if it is not included in the specified CPUs. In this embodiment, since all the CPUs installed in the computer 100 are specified to be utilized, no CPU is halted. If a physical CPU under execution is included in the CPUs that execute the OS, it is examined whether or not the physical number of the CPU matches the logical number of a logical CPU executed by the physical CPU (step 707). If the two numbers match, the process is continued as it is. If the physical CPU under execution is executing the process associated with a CPU having a logical number different from the physical number of the physical CPU under execution, the status of a logical CPU having the same logical number as the physical number is restored from the CPU management table 600 (step 708), and the execution of the logical CPU is resumed.

The foregoing process performs the CPU-inherent initialization for CPUs which are not actually installed in the computer 100, with the result that only the physical CPUs (CPUs installed in the computer 100) execute the OS. Also, the status of each CPU after completion of the initialization is held in the CPU status 603 of the CPU management table 600, and the internal data structure of the OS, required for each CPU, has also been initialized. These data structures are referenced when the respective CPUs are executing the OS, but do not affect the execution of the OS if associated CPUs are not executing.

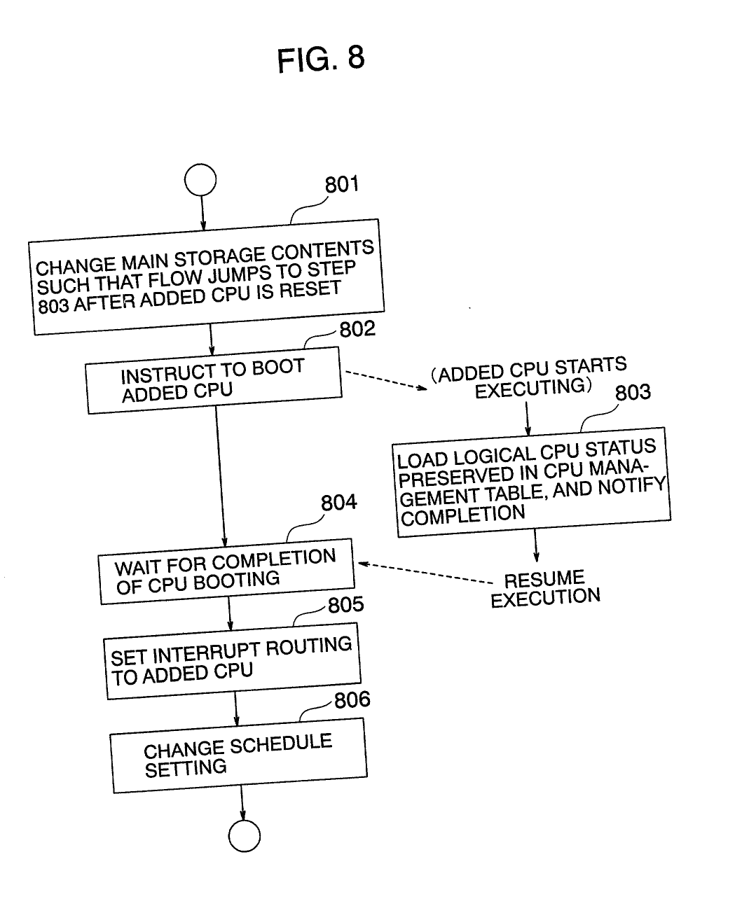

FIG. 8 is a flow chart illustrating an exemplary process of adding a CPU.

In this example, it is assumed that the CPU addition process is started in response to an instruction from an operator of the computer 100. The following description will be made for addition of an N-th CPU. When a CPU is added to the computer 100 and the operator issues instructions associated with the addition of the CPU, the IPL 110 in the memory 109 is first rewritten such that a process from step 803 is executed by a module that does the process to add a processor, when the added CPU is booted (step 801). Subsequently, an instruction for booting the added CPU is executed (step 802). The added CPU is booted, and the control is passed to step 803. At step 803, the status of the N-th logical CPU preserved in the CPU management table 600 is restored, and the execution of the N-th logical CPU is resumed. In the main process, the flow waits until the added CPU is completely booted (step 804), at which time interrupt routing is set for the added CPU (step 805), and associated parameters of the scheduler are changed (step 806), thereby allowing the added CPU to participate in the execution of the OS. At this time, the status of a logical CPU used by the added CPU, and the internal data structures allocated by the OS to the respective CPUs have already been ready, so that the added CPU can be immediately joined in the execution of the OS as the N-th CPU.

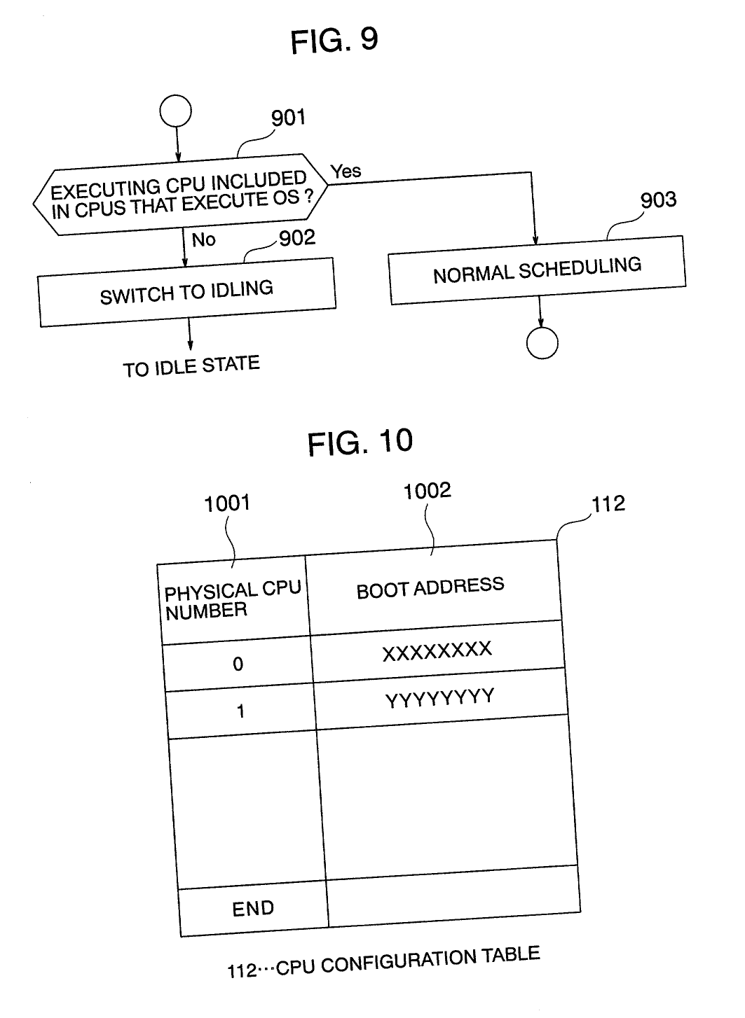

FIG. 9 is a flow chart for explaining the scheduler of the OS. In this embodiment, a parameter of the scheduler is changed to restrict the number of CPUs that execute the OS. This involves, for example, providing a data structure in the OS for representing CPUs that execute the OS, for use when the scheduler is executed, to examine a logical CPU number of a CPU on which the scheduler is running (step 901), and forcedly transitioning the CPU to an idle state if the CPU is not included in the CPUs that execute the OS (step 902). If the CPU under execution is included in the CPUs that execute the OS, the normal scheduling is performed (step 903).

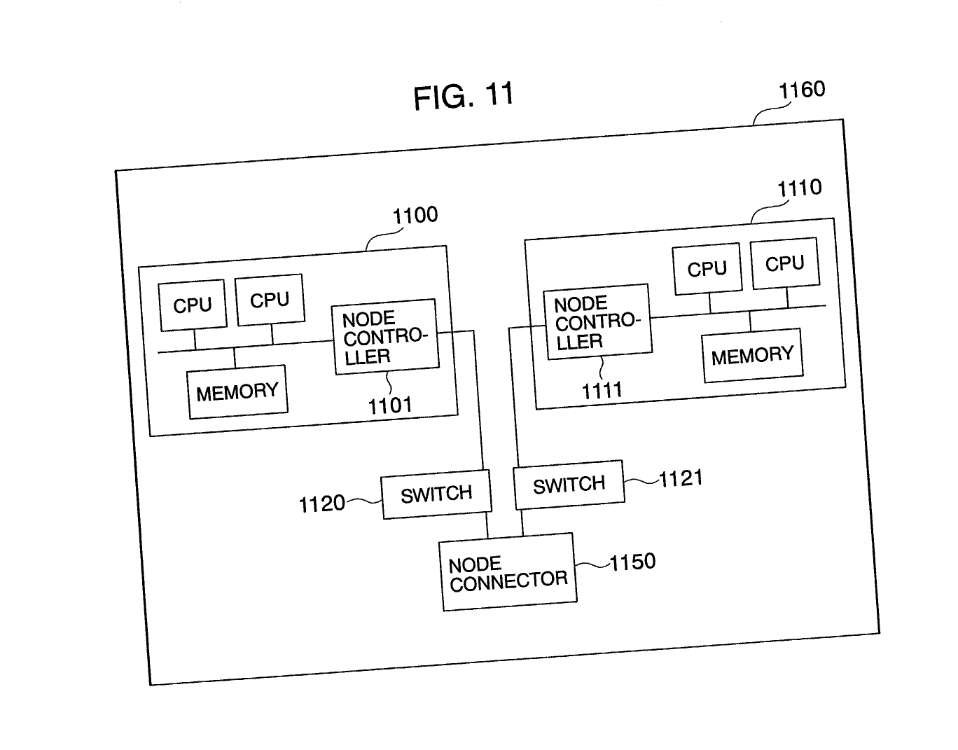

FIG. 10 shows the structure of the CPU configuration table 112.

The CPU configuration table 112 has a physical CPU number 1001 for storing physical CPU numbers of CPUs actually installed in the computer 100; and a memory address 1002 for storing a memory address into which an instruction is written when an associated CPU is booted. “END” in the physical CPU number 1001 indicates the end of the CPU configuration table 112. The CPU configuration table 112 is created by the IPL 110 when the computer 100 is started. The CPU virtualization program 111 rewrites the CPU configuration table 112 such that it appears that a larger number of CPUs than actually installed are installed in the computer 100. Also, the CPU virtualization program 111 extends the CPU configuration table 112 to create a table which shows as if more CPUs are installed than they actually are. Further, the CPU virtualization program 111 sets the boot address 1002 of an added row to an address at which a trap is generated if this address is accessed, thus trapping an attempt of the OS to boot a CPU which is not installed.

In the foregoing embodiment, a CPU may be added to the computer 100 during its execution even if the OS does not support the dynamic CPU addition. Generally, in order to enable a CPU to be added to a computer during its execution, its OS must be configured on the assumption that additional CPUs will be installed in the computer at a later time. According to this embodiment, however, the dynamic CPU addition can be accomplished only by adding minor changes the OS, i.e., the scheduler, setting of CPUs to which interrupts are routed, additionally specified CPUs that execute the OS, and so on.

The foregoing embodiment has been described for a system in which a privileged instruction executed by the OS is trapped to trap a CPU boot instruction, so that the CPU virtualization program 111 takes the control to force the OS to virtually execute the CPU initialization. Alternatively, the CPU boot instruction only may be trapped, or the OS may directly call the CPU virtualization program 111. Also, while in the foregoing embodiment, the CPU virtualization program 111 rewrites the CPU configuration table 112 such that it appears to the OS that there are a larger number of CPUs than the number of actually installed CPUs, the CPU boot module 211 of the OS may be designed to support the CPU addition so that the CPU boot process is executed as well for virtual CPUs which are not installed in the computer 100. Further, while in the foregoing embodiment, the privileged instruction emulator 203 is provided in the CPU virtualization program 111 to boot a virtual CPU out of the OS, the booting of a virtual CPU may be performed in the OS. Specifically, the CPU boot module 211 of the OS is modified to be associated with the CPU virtualization program 111 provided in the OS.

FIG. 11 is a block diagram illustrating an exemplary configuration of a computer according to another embodiment of the present invention.

This embodiment illustrates an exemplary configuration in which a CPU is added in units of nodes which include CPUs. A computer 1160 comprises nodes 1100, 1110, and a node connector 1150 which interconnects the nodes 1100, 1110. In FIG. 11, each of the nodes 1100, 1110 comprises a CPU, a memory, and a node controller. A node controller 1101 in the node 1100 is connected to the node connecter 1150 through a switch 1120, while a node controller 1111 in the node 1110 is connected to the node connecter 1150 through a switch 1121. The node controller 1101 controls communications with CPUs external to the node 1100, and reference to the memory. The node connecter 1150 implements communications between CPUs and data transfer between nodes in association with the node controllers 1101, 1111 in the respective nodes 1100, 1110. A node is configured per se as a unit removable from and installable into the computer 1160, and its connection with the node connector 1150 is controlled by the switches 1120, 1121. The switch 1120 has signal lines for notifying the node controller 1101 and the node connector 1150 of a change in the connection state. Also, the node connector 1150 generates an interrupt, when a switch connected thereto has changed its connection state, to notify the OS running on the computer 1160 of the change in the connection state.

The following description will be made on the flow of the CPU addition when the node 1110 is newly connected to the node connector 1150. Assuming first that a total of four CPUs are installed in the computer 1160 (two in the node 1100 and another two in the node 1110), the OS running on the computer 1160 is started such that the two CPUs installed in the node 1100 execute the OS.

Next, the operator of the computer 1160 manipulates the switch 1121 connected to the node 1110 to connect the node 1110 to the node connector 1150. A change in the connection state is notified from the switch 1121 to the node connector 1150 which generates an interrupt to the node 1100. In this way, the OS on the node 1100 can recognize that there are additionally installed CPUs. The node controller 1111 of the node 1110 is also notified of the connection of the node 1110 to the node connector 1150, so that the node controller 1111 executes the initialization in the node 1110. The OS configures the node connector 1150 such that communications are available between the nodes 1100 and 1110. Subsequently, the OS executes the CPU addition in a manner similar to the aforementioned embodiment in response to an instruction of the operator or automatically.

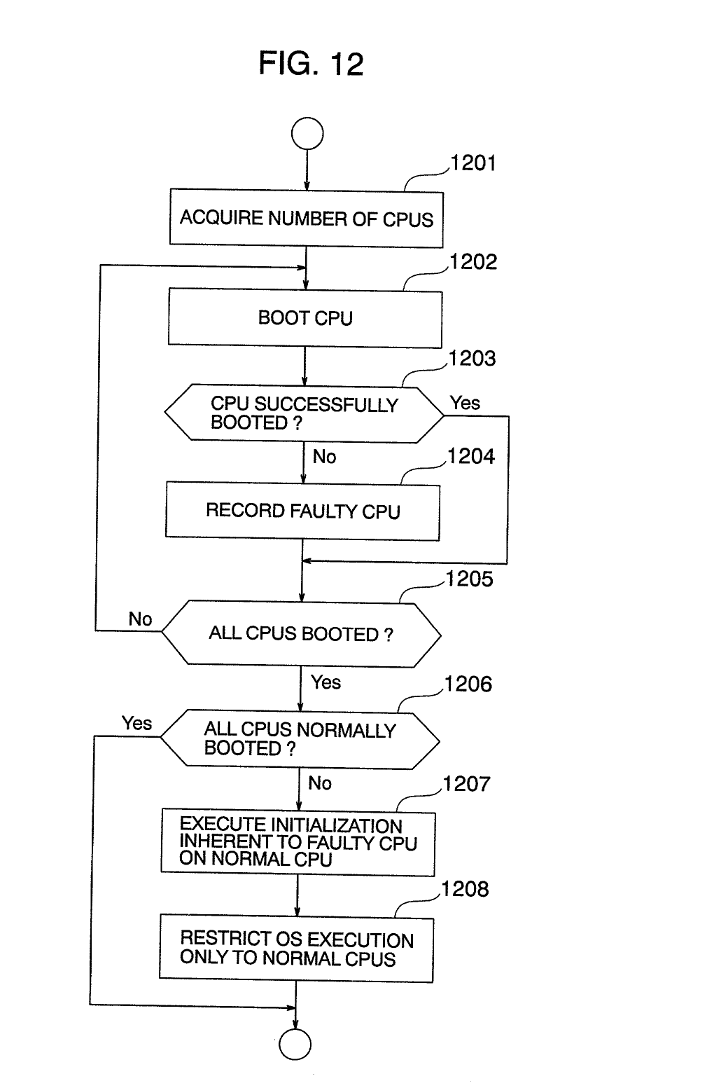

FIG. 12 is a flow chart for explaining a further embodiment of the present invention, and more specifically, illustrating a procedure executed by the OS to boot CPUs when some CPU installed in a computer fails and is not therefore booted normally.

In this embodiment, when a CPU installed in a computer fails and is not normally booted, the CPU virtualization program 111 is relied on to have a normal CPU execute the initialization inherent to the faulty CPU, in place of the faulty CPU. Subsequently, when the faulty CPU is replaced with a normal CPU, a CPU addition procedure is performed to restore the normal execution status. Here, the description is made on the assumption that the CPU 102 in the computer 100 of FIG. 1 is a faulty CPU which cannot be booted.

At step 1201, the CPU configuration table 112 is referenced to acquire the number of CPUs installed in the computer 100. Then, the process from step 1202 to step 1205 is executed for the CPUs installed in the computer 100 except for the bootstrap CPU. First, a CPU boot instruction is executed to boot a CPU (step 1202). It is next determined whether or not the CPU has been normally booted (step 1203). This determination examines whether or not the initialization inherent to the CPU, executed by the OS, has been normally completed. If the CPU is faulty and is not normally booted, this CPU is recorded as a faulty CPU (step 1204).

When all the CPUs have been booted (step 1205), it is examined whether or not any faulty CPU has been found (step 1206). If a faulty CPU has been found, a virtual CPU is booted. Specifically, one of the installed CPUs, for example, the CPU 103 is selected, and the status of a logical CPU to be otherwise executed by the faulty CPU 102 is virtually created on the CPU 103, so that the OS executes the initialization inherent to the faulty CPU on the CPU 103 (step 1207). Finally, the OS restricts CPUs that execute the OS to those CPUs which have been normally booted (step 1208), so that the OS executes the subsequent OS-based process only with the normal CPUs.

In this example, the CPU 101 is allocated to the first logical CPU, and the CPU 103 to the second CPU. When the faulty CPU is removed and replaced with a normal CPU, the CPU addition procedure, previously described in the aforementioned embodiment, is executed to bring the computer 100 into the normal execution status. Here, as the CPU 102 is replaced with a normal CPU, the normal CPU is joined in the execution of the OS as the third CPU.

The program for executing the method of adding a processor according to the present invention may be delivered through a communication means, or stored in a computer readable recording medium such that the program is read into a memory for execution.

According to this embodiment, the computer 100 can be started even if any of the CPUs installed in the computer 100 is faulty and cannot be booted. In addition, the initialization inherent to each CPU is executed, including the faulty CPU, upon booting, so that when the faulty CPU is replaced with a normal CPU at a later time, the CPU can be immediately joined in the execution of the OS.

According to the present invention, even with a computer in which a CPU to be dynamically added is not previously installed, such a CPU can be added during the execution of the OS. Also, even if a faulty CPU is found upon starting the OS, a substitutive normal CPU can be joined in the execution of the OS without restarting the OS.

What is claimed is:

1. A method of adding a processor during execution of an operating system (OS) comprising:
a first step of virtually forming a first processor to be installed in a computer when the OS is started;
a second step of executing OS initialization inherent to said virtually formed first processor on second processor which is one of processors installed in said computer;
a third step of specifying processors among processors installed in said computer; and
a fourth step, executed when a third processor is added, of loading a result of said initialization into said third processor and joining said third processor in the execution of the OS as said first processor.

2. A method of adding a processor during execution of an operating system (OS) comprising:
a first step of virtually forming a first processor to be installed in a computer when the OS is started;
a second step of selecting one from at least one second processor which has been installed in said computer before the OS boots said first processor to preserve status of said selected second processor;
a third step of executing OS initialization inherent to said first processor on said selected second processor instead of said first processor;
a fourth step of preserving the status of said selected second processor as status of said first processor after said initialization;
a fifth step of restoring the preserved status of said selected second processor to resume the execution of the OS; and
a sixth step, executed when said third processor is added, of restoring the status of said first processor reserved during said initialization to said added third processor to join said third processor in the execution of the OS.

3. A method of adding a processor according to claim 2, wherein in said third step, said selected second processor executes its own process and the OS initialization inherent to said first processor in a time slice.

4. A method of adding a processor according to claim 2, wherein said second to fifth steps are invoked and executed by the OS when the OS boots a processor.

5. A method of adding a processor according to claim 2, wherein said second to fifth steps are executed when a processor boot process of the OS is trapped, and a processor to be booted is said first processor.

6. A method of adding a processor according to claim 2, wherein said second to fifth steps are executed as a program independent of the OS.

7. A method of adding a processor according to claim 2, wherein said first step is executed as a program independent of the OS.

8. A method of adding a processor according to claim 2, wherein said first step of virtually forming a first processor is terminated when the initialization of the OS is terminated.

9. A method of adding a procedure during execution of an operating system (OS), comprising:
a first step of virtually forming a first processor to be installed in a computer when the OS is started;
a second step of executing OS initialization inherent to said virtually formed first processor on second processor which is one of processors installed in said computer;
a third step of specifying processors among processors installed in said computer;
a fourth step of scheduling a process such that the OS is executed only on said processors specified by said third step;
a fifth step of routing an external interrupt from a device to said processors specified by said third step; and
a sixth step of joining said first processor loaded with a result of said initialization in the execution of the OS when a processor is added.

10. A method of adding a processor according to claim 2, wherein said first step is executed when the OS is initialized and when a processor is added.

11. A method of replacing a processor during execution of an operating system (OS), comprising:
a first step of booting at least one processor;
a second step of determining whether or not each said processor has been successfully booted at said first step;
a third step of continuing the booting of processors except for a faulty processor which is determined to fail in the booting;
a fourth step of executing OS initialization inherent to said faulty processor on one of said normally booted processors after all the processors have been booted;
a fifth step of forcing said normally booted processors to execute the OS; and
a sixth step, executed when said faulty processor is replaced with a normal additional processor, of loading a result of said initialization into said additional processor and joining said additional processor in the execution of the OS.

12. A method of adding a processor according to claim 2, wherein a node including at least one processor is added.

13. A computer capable of adding a processor during execution of an operating system (OS), comprising:
means for virtually forming a first processor to be installed in said computer when the OS is started;
means for forcing at least one second processor which is one of processors installed in said computer to execute OS initialization inherent to said virtually formed first processor;
means for specifying processors among processors installed in said computer and forcing said specified second processor to execute the OS after said initialization; and
means operative when a third processor is actually added for joining said third processor, loaded with a result of said initialization, in the execution of the OS as said first processor.

14. A computer capable of adding processor during execution of an operating system (OS), comprising:
means for virtually forming a first processor to be installed in said computer when the OS is started;
means for selecting one from at least one second processor which has been installed in said computer before the OS boots said first processor to preserve status of said selected second processor;
means for executing OS initialization inherent to said first processor on said selected second processor instead of said first processor;
means for preserving the status of said selected second processor as status of said first processor after said initialization;
means for restoring the preserved status of said selected second processor to resume the execution of the OS; and
means operative when said third processor is added for restoring the status of said first processor reserved during said initialization to said added third processor to join said third processor in the execution of the OS.

15. A computer readable recording medium having storing thereon a program for executing a method of adding a processor during execution of an operating system (OS), said method comprising:
a first step of virtually forming a first processor to be installed in a computer when the OS is started;
a second step of executing OS initialization inherent to said virtually formed first processor on second processor which is one of processors installed in said computer;
a third step of specifying processors among processors installed in said computer; and
a fourth step, executed when said virtually formed first processor is added, of loading a result of said initialization into said first processor and joining said first processor in the execution of the OS.

16. A computer executable program for executing a method of adding a processor during execution of an operating system (OS), said method comprising:
a first step of virtually forming a first processor to be installed in a computer when the OS is started;
a second step of executing OS initialization inherent to said virtually formed first processor on second processor which is one of processors installed in said computer;
a third step of specifying processors among processors installed in said computer; and
a fourth step, executed when said virtually formed first processor is added, of loading a result of said initialization into said first processor and joining said first processor in the execution of the OS.
